(19) United States
(12) Patent Application Publication
(10) Pub. No.: US 2015/0052999 A1
(43) Pub. Date: Feb. 26, 2015

(54) rotational rate sensor having preset quadrature offset

(71) Applicants: Rolf Scheben, Stuttgart (DE); Christoph Gauger, Geislingen Bei Balingen (AU); Markus Heitz, Mount Eliza (AU)

(72) Inventors: Rolf Scheben, Stuttgart (DE); Christoph Gauger, Geislingen Bei Balingen (AU); Markus Heitz, Mount Eliza (AU)

(73) Assignee: Robert Bosch GmbH, Stuttgart (DE)

(21) Appl. No.: 14/467,943

(22) Filed: Aug. 25, 2014

(30) Foreign Application Priority Data
Aug. 26, 2013 (DE) 10 2013 216 935.3

(51) Int. Cl. G01C 19/5747; G01C 19/5769

(52) U.S. Cl. CPC G01C 19/5747; G01C 19/5769
USPC 73/504.12; 29/592

(57) ABSTRACT

A rotational rate sensor includes a substrate and a seismic mass situated thereon, and configured for detecting a rate of rotation about a rotation axis, the seismic mass having a second mass element coupled to a first mass element, which is drivable to a drive movement along a drive direction perpendicular to the rotation axis, the first and second mass element being deflectable along a detection direction essentially perpendicular to the drive direction and to the rotation axis, the rotational rate sensor having at least one compensating arrangement to produce a compensating force acting on the second mass element, the compensating force being oriented in a compensation direction essentially parallel to the detection direction, the at least one compensating arrangement being the only compensating arrangement and being configured exclusively to produce the compensating force oriented in the compensation direction, the rotational rate sensor being configured such that a quadrature offset force acting on the second mass element is directed exclusively in a preferred direction opposite and parallel to the compensation direction.

### RELATED APPLICATION INFORMATION

The present application claims priority to and the benefit of German patent application no. 10 2013 216 935.3, which was filed in Germany on Aug. 26, 2013, the disclosure of which is incorporated herein by reference.

### FIELD OF THE INVENTION

The present invention is based on a rotational rate sensor.

### BACKGROUND INFORMATION

Such rotational rate sensors are generally known. For example, it is generally known that rotational rate sensors have a driven mass on which a Coriolis force can act, and a deflection resulting therefrom can be detected. Typically, as a result of the production process there are asymmetrical realizations of sensor elements of the rotational rate sensors, so that for example disturbing forces, or oblique forces, are produced that increase in linear fashion with the deflection. Such force components are standardly referred to as quadrature forces. These quadrature forces are a problem because it is often the case that, due to the magnitude of these quadrature signals, it is difficult to recognize a Coriolis force. For example, for the separate detection of quadrature forces and Coriolis forces, a comparatively high input range of a measurement electronics system of the rotational rate sensor is required. Constructive measures are known in which quadrature forces can be compensated already in the sensor element through electrical counter-forces. Standardly, the quadrature forces occur in both directions.

### SUMMARY OF THE INVENTION

It is therefore an object of the present invention to provide a rotational rate sensor, a method for producing a rotational rate sensor, and/or an improved quadrature compensation method, in which the constructive size of the rotational rate sensor is reduced and/or the evaluation circuit can be made with a simpler configuration, while nonetheless achieving a reliable quadrature compensation.

In comparison with the existing art, the rotational rate sensor according to the present invention, the method according to the present invention for producing a rotational rate sensor, and the quadrature compensation method according to the present invention according to the coordinate claims have the advantage that through the exclusively one compensation arrangement configured to produce the compensating force, or through the quadrature offset force directed exclusively in the preferred direction, the constructive size of the rotational rate sensor is reduced, while a reliable quadrature compensation is nonetheless achieved. In this way, a further compensating arrangement, configured to produce a different compensating force acting on the second mass element and directed opposite to the compensating force, is saved. In contrast to the known rotational rate sensors, the rotational rate sensor is configured in such a way that it is sufficient to preset compensating forces having a directional sign. In particular, the rotational rate sensor is fashioned in such a way that already as a result of its configuration a defined quadrature offset force, here also referred to as an oblique force or artificial quadrature, is impressed. This is done with the goal that further oblique forces resulting due to the production process produce, in sum together with the preset quadrature offset force, only overall quadrature forces having exclusively one directional sign. This means for example that the overall quadrature force results from a quadrature force and the additionally produced quadrature offset force, the quadrature offset force always being directed in the preferred direction, independent of the orientation of the quadrature force, and being significantly greater than the quadrature force. In this way, advantageously in particular only the at least one compensating arrangement is required for the compensation of the quadrature, because only one force sign is applied. In particular, the at least one compensating arrangement is configured as a quadrature compensation electrode.

The rotational rate sensor may be configured for the detection of a further rotational rate about a further axis of rotation perpendicular to the axis of rotation, the rotational rate sensor having at least one further compensating arrangement. The rotational rate sensor may be configured for the detection of a still further rotational rate about a still further axis of rotation perpendicular to the axis of rotation and to the further axis of rotation, the rotational rate sensor having at least one still further compensating arrangement. In this way, according to the present invention for each axis of rotation a compensating arrangement, in particular a compensating electrode, its wiring, and an associated connection to the evaluation circuit of the rotational rate sensor, is saved. In this way, the constructive size of the rotational rate sensor and the production costs are still further reduced. In particular in rotational rate sensors having bonding pad lines, the number of sensor connections to a contact arrangement for connecting the rotational rate sensor to an external connecting arrangement is a limiting factor for the system size or extension of the rotational rate sensor. Here as well, according to the present invention it is advantageously possible to further reduce the space requirement. In addition, savings of for example production costs are also conceivable through possible optimizations in an evaluation circuit of the rotational rate sensor according to the present invention.

Advantageous embodiments and developments of the present invention can be learned from the subclaims and from the description with reference to the drawings.

The substrate may have a main plane of extension. The axis of rotation may be situated essentially parallel or essentially perpendicular to the main plane of extension. The first mass element and the second mass element may be coupled with one another in spring-elastic fashion via a spring system according to the present invention. Alternatively, in particular the first and second mass element can be coupled immovably to one another; in this case, the seismic mass is for example fashioned in one piece. The drive direction may be essentially parallel or perpendicular to the main plane of extension of the substrate. The detection direction may be essentially parallel or essentially perpendicular to the main plane of extension of the substrate. The seismic mass may be driven to a linear oscillation along the drive direction and/or to a rotational oscillation; in the case of a rotational oscillation, an axis of oscillation about which the rotational oscillation takes place is essentially perpendicular to a plane of oscillation, the drive direction being situated in the plane of oscillation. The seismic mass may be excited to a detection oscillation as a function of a Coriolis force, the detection oscillation for example being a linear oscillation along the direction of detection and/or a further rotational oscillation about a further axis of oscillation. For example, the plane of oscillation is essentially parallel to the main plane of extension and the further axis of oscillation is essentially parallel to the plane of oscillation and perpendicular to the axis of rotation.

According to a development, it is provided that the rotational rate sensor has a quadrature offset arrangement, the quadrature offset arrangement being configured to produce a quadrature offset force acting on the second mass element, the quadrature offset force being oriented in a preferred direction essentially opposite and parallel to the compensation direction. In particular, the quadrature offset arrangement is a spring system according to the present invention, an electrode system, and/or a structure of the rotational rate sensor, each of which is/are fashioned such that the quadrature offset force oriented or directed in the preferred direction is produced.

According to a further development, it is provided that the rotational rate sensor has a spring system that is configured to produce the quadrature offset force directed in the preferred direction. In this way, it is advantageously possible to provide, with comparatively simple arrangement, a rotational rate sensor that has exclusively the quadrature offset force acting in the preferred direction, which is superposed on a quadrature force produced by scattering in the production process. In this way, the space requirement can advantageously be reduced and the production costs can be lowered.

According to a further development, it is provided that the first mass element is coupled to the second mass element by a spring element of the spring system, the spring element being pre-tensioned to produce the quadrature offset force directed in the preferred direction. The first mass element may be coupled to the second mass element by a plurality, in particular four, spring elements of the spring system, the plurality, in particular four, spring elements being pre-tensioned in order to produce the quadrature offset force directed in the preferred direction. In this way, it is advantageously possible to produce the quadrature offset force through the realization of the spring elements in a particularly simple and efficient manner.

According to a further development, it is provided that the spring system has a plurality of spring elements that couple the first and second mass element, the plurality of spring elements of the spring system having different spring characteristics, the spring characteristic being in particular a spring structure width, a spring structure height, a spring length, a spring cross-section extending essentially parallel to the drive direction, a spring type, a spring rigidity sensor, and/or a spring material. In this way, it is advantageously possible through a multiplicity of exemplary possibilities to provide exclusively the at least one compensating arrangement configured to produce the compensating force, and/or to configure the rotational rate sensor in such a way that a quadrature offset force acting on the second mass element is directed exclusively in a preferred direction opposite and parallel to the compensation direction.

According to a further development, it is provided that
the spring structure widths of at least two spring elements of the plurality of spring elements differ by from 3 to 40 nm, which may be 5 to 30 nm, particularly may be 10 to 20 nm, and/or
the spring lengths of at least two spring elements of the plurality of spring elements differ by from 0.2 to 10 μm, which may be 0.3 to 8 μm, particularly may be 0.5 to 5 μm, and/or
the spring structural heights of at least two spring elements of the plurality of spring elements differ by from 0.1 to 3 μm, which may be 0.2 to 2 μm, particularly may be 0.3 to 1.5 μm.

In this way, it is advantageously possible to produce the quadrature offset force in a particularly simple and efficient manner.

According to a further development, it is provided that the first mass element is formed at least partly from a first functional layer applied on the substrate, and the second mass element is formed at least partly from a second functional layer applied on the first functional layer, the first functional layer and second functional layer being situated one over the other along a direction of projection perpendicular to a main plane of extension of the substrate, the spring element of the spring system being coupled at a first end to the first mass element, the spring element of the spring system being coupled at a second end to the second mass element. In this way, it is advantageously possible, through such a realization of the spring elements, to produce the quadrature offset force in a particularly simple and efficient manner even in a direction of projection essentially perpendicular to the main plane of extension.

According to a further development, it is provided that the spring element has a spring cross-sectional surface extending along a cross-sectional plane, the cross-sectional plane being essentially parallel to the drive direction and essentially parallel to the direction of projection, in particular the spring cross-sectional surface being fashioned asymmetrically relative to a, or each, mirroring axis running along the spring cross-sectional surface, the spring cross-sectional surface being in particular L-shaped, or having an opening extending from an edge into the spring cross-sectional surface, extending essentially parallel to the direction of projection and/or essentially parallel to the drive direction. In this way, it is advantageously possible through such a realization of the spring elements to produce the quadrature offset force in an efficient manner.

According to a further development, it is provided that the at least one compensating arrangement is configured for the compensation of at least the quadrature offset force oriented in the preferred direction by the compensating force oriented in the compensating direction, the compensating force and the quadrature offset force in particular essentially canceling one another. The compensating force may be set as a function of the quadrature offset force, in particular by a closed control and regulation circuit of the rotational rate sensor. In this way, it is advantageously possible to produce the quadrature offset force in a particularly simple and efficient manner.

According to a further development, it is provided that the at least one compensating arrangement is a compensating electrode connected to the substrate, the compensating electrode being configured to produce the compensating force as a function of a quadrature voltage applied between the compensating electrode and the second mass element. In this way, it is advantageously possible to compensate the quadrature using only a single compensating electrode.

Exemplary embodiments of the present invention are shown in the drawings and are explained in more detail in the following description.

### BRIEF DESCRIPTION OF THE DRAWINGS

FIG. 1 shows a rotational rate sensor according to a specific embodiment of the present invention in a schematic top view.

FIG. 2 shows a rotational rate sensor according to a specific embodiment of the present invention in a perspective view.

FIGS. 3 through 5 each show a compensating arrangement according to various specific embodiments of the present invention in a schematic top view.

FIG. 6 shows a rotational rate sensor according to a specific embodiment of the present invention in a perspective view.

FIGS. 7 and 8 are spring elements according to various specific embodiments of the present invention in a schematic sectional view.

### DETAILED DESCRIPTION

In the various Figures, identical parts have always been provided with identical reference characters, and are therefore as a rule named or mentioned only once.

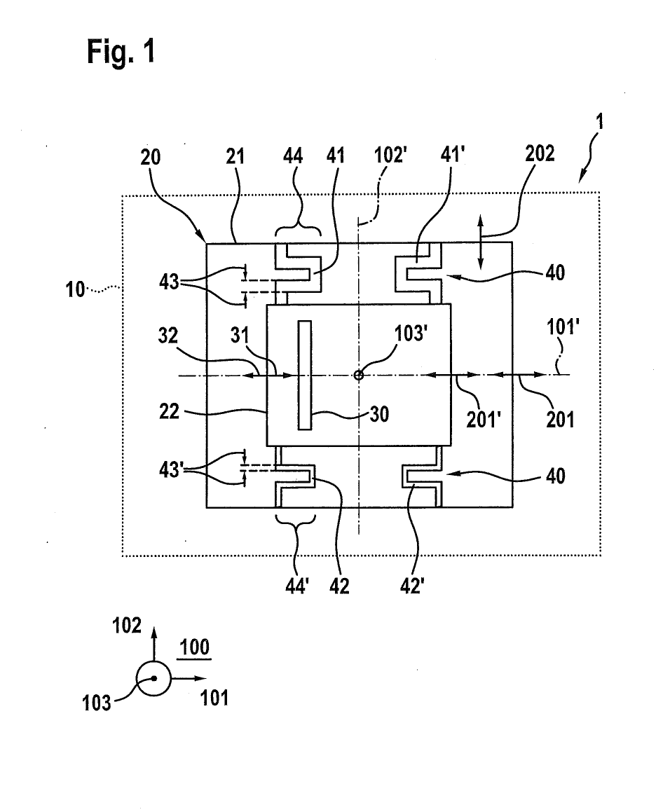

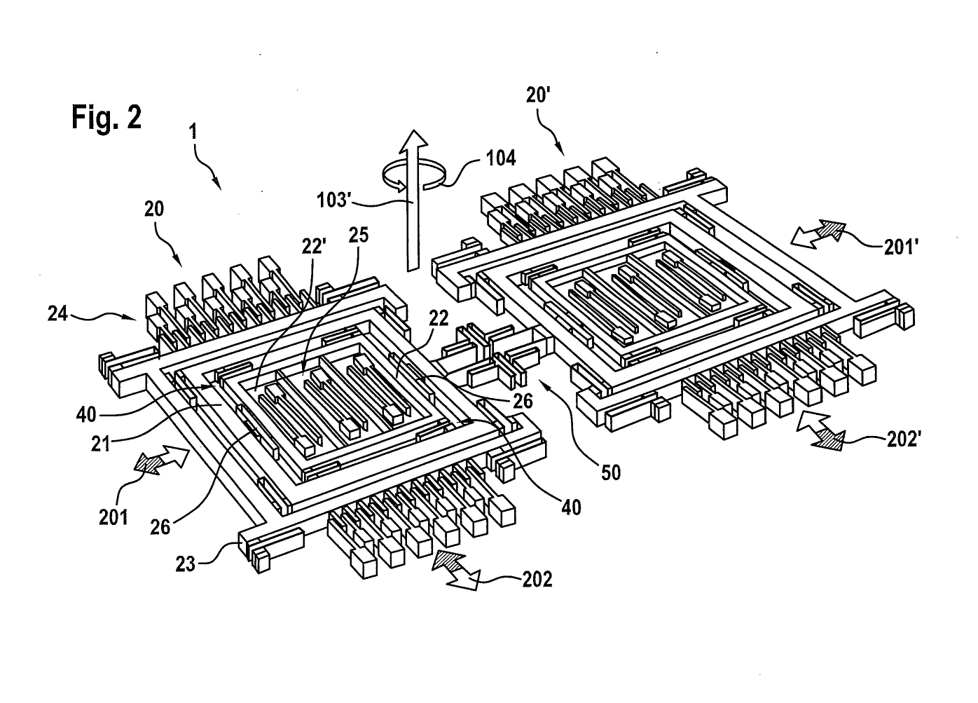

FIG. 1 shows a rotational rate sensor 1 according to a specific embodiment of the present invention in a schematic top view. Rotational rate sensor 1, here shown schematically, includes a substrate 10 having a main plane of extension 100 and a seismic mass 20 situated on substrate 10. Here, rotational rate sensor 1 is configured for the detection of a rotational rate 104 (see FIG. 2) about an axis of rotation 103′. Seismic mass 20 here extends, in a rest position, mainly along a plane essentially parallel to main plane of extension 100. Seismic mass 20 has a first mass element 21 and a second mass element 22 coupled to first mass element 21. Here, first mass element 21 and second mass element 22 are fashioned in the shape of a frame. In addition, first mass element 21 is capable of being driven to a drive movement 202 along a drive direction 102′ perpendicular to axis of rotation 103′. In addition, in particular first mass element 21 is coupled to the second mass element via a spring system 40 in such a way that a drive movement 202 of first mass element 21 along drive direction 102′, here also called Y direction 102, is not (or is only slightly) transmitted to second mass element 22. This means for example that second mass element 22 is connected essentially in stationary fashion to substrate 10 with regard to a movement along drive direction 102′.

In contrast, both first mass element 21 and also second mass element 22 are capable of being deflected along a direction of detection 101′ that is essentially perpendicular both to drive direction 102′ and to axis of rotation 103′, for example as a function of a Coriolis force acting on first mass element 21 and/or as a function of a quadrature force. For example, first mass element 21 executes a first deflection movement 201 parallel to detection direction 101′, and second mass element 22 executes, in particular due to its coupling to first mass element 21, a second deflection movement 201′ parallel to detection direction 101′. Here, the quadrature force is for example a quadrature force impressed by the production process, which, even if rotational rate sensor 1 is not charged with a rotational rate 104, results in a deflection of first and/or second mass element 21, 22 along detection direction 101′ when first mass element 21 is driven to drive movement 202. The quadrature force here can, for example randomly (due to the production process), be oriented both essentially parallel to detection direction 101′ and also in the opposite direction parallel to detection direction 101′.

According to the present invention, it is advantageous that rotational rate sensor 1 has at least one compensating arrangement 30, the at least one compensating arrangement 30 being configured to produce a compensating force, the compensating force being oriented in a compensation direction 31 essentially parallel to detection direction 101′. In this way, it is advantageously possible for the quadrature force to be capable of being compensated for example by compensating arrangement 30. In the example shown in FIG. 1, the compensating force for example acts directly on second mass element 22; alternatively, compensating arrangement 30 can also be situated inside another mass element, in particular the first mass element.

The at least one compensating arrangement 30 may be the only compensating arrangement 30 of the rotational rate sensor, the at least one compensating arrangement 30 being configured exclusively to produce the compensating force oriented in compensation direction 31. In particular, at least one single compensating arrangement here means that there can also exist two, three, four, or more compensating arrangement 30 fashioned in the same manner, but however in particular each at least one compensating arrangement 30 is configured only such that in each case a compensating force is exclusively produced that is oriented in compensation direction 31. In addition or alternatively, the statement that the at least one compensating arrangement 30 is configured exclusively to produce the compensating force oriented in compensation direction 31 means that rotational rate sensor 1 has no other compensating arrangement 30′ configured to produce another compensating force in a further compensation direction 31′ opposite and parallel to compensation direction 31.

According to an alternative specific embodiment or a development, rotational rate sensor 1 is configured such that a quadrature offset force acting on second mass element 22 is directed exclusively in a preferred direction 32 opposite and parallel to compensation direction 31. The provision of only the at least one compensating arrangement 30 is for example therefore adequate and preferred according to the present invention, because rotational rate sensor 1 is preset in such a way that, independently of the random direction of the quadrature force, a quadrature offset force is produced that for each sensor is always oriented in a preferred direction 32 that is directed opposite to compensation direction 31. In particular, compensating arrangement 30 is configured for the compensation of an overall quadrature force that is essentially equal to a vector sum of the quadrature offset force and the quadrature force.

According to an alternative specific embodiment or a development, rotational rate sensor 1 has in particular only a single compensating arrangement 30 that is configured to produce a compensation force acting on second mass element 21 and oriented in compensation direction 31.

According to an alternative specific embodiment or a development, rotational rate sensor 1 has in particular a quadrature offset arrangement 40, quadrature offset arrangement 40 being configured to produce a quadrature offset force acting on first and/or second mass element 21, 22, the quadrature offset force being oriented essentially in a preferred direction 32 opposite and parallel to compensation direction 31.

In particular, here compensating arrangement 30 is a compensating electrode that is for example situated in a recess 22′ of second mass element 22 and in particular is connected in stationary fashion to the substrate. Alternatively, compensating arrangement 30 is situated between first and second mass element 21, 22, or outside both first and second mass element 21, 22.

Here, spring system 40 has a plurality of spring elements 41, 41′, 42, 42′ that couple the first and second mass element 21, 22, the spring system here in particular including four spring elements 41, 41′, 42, 42′.

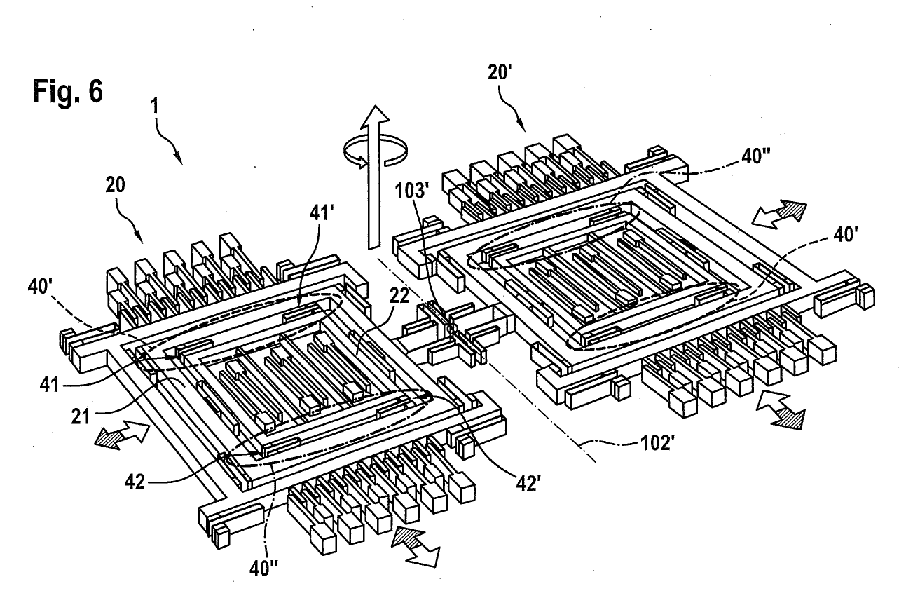

In coupled systems, cf. FIG. 2 and FIG. 6, for example the structural widths of springs (i.e. spring elements 41, 41′, 42, 42′) of the partial oscillators are modified in the same way at each side. The axis of symmetry that is relevant here is the axis of the overall sensor in the drive direction.

For non-coupled systems, as shown for example in FIG. 1, for example first spring element 41 can be increased and second spring element 42 can be reduced in the same manner, while spring element 41′ and spring element 42′ remain unmodified. Analogously, other pairs can also be formed, e.g. spring element 41′ and spring element 42, or spring element 41 and spring element 42′, or spring element 41′ and spring element 42′, or spring element 41 and spring element 41′, or spring element 42 and spring element 42′. It is also conceivable (instead of a modification of two spring elements) for there to be a modification of a plurality of springs (for example three or four), so that the overall spring rigidity remains the same, but, relative to the axis of the drive direction through the sensor center of gravity, there remains no symmetry of the system.

In addition, a spring structural height, a first and second spring length 44, 44′, a spring cross-sectional surface 400′ extending essentially parallel to drive direction 202, a spring type, a spring rigidity sensor, and/or a spring material can also be different.

FIG. 2 shows a rotational rate sensor 1 according to a specific embodiment of the present invention, in a perspective view. Rotational rate sensor 1 shown here corresponds essentially to the specific embodiment shown in FIG. 1, with the difference that here two seismic masses 20, 20′ are present, coupled via a coupling arrangement 50. Seismic mass 20 and a further seismic mass 20′ of the rotational rate sensor are here fashioned essentially identically. Therefore, here details are described only relating to seismic mass 20, and the description is to be taken as applying correspondingly also to the further seismic mass. Seismic mass 20 has a drive arrangement 24, in particular a comb electrode, in order to bring about drive movement 202 of first mass element 21; here first mass element 21 is coupled to a drive frame 23 that is provided in order to transmit the drive energy of drive arrangement 24 to first mass element 21. Second mass element 22 is here coupled to first mass element 21 via spring system 40, and, by a substrate bonding 26, is attached in stationary fashion to substrate 10 relative to a movement into drive device 102′. This means that second mass element 22 is here capable of being deflected essentially along detection direction 101′, and in particular can be excited to detection movement 201. Further mass element 20′ is correspondingly driven to a further drive movement 202′, and in particular drive movement 202 and further drive movement 202′ are opposite in phase. If rotational rate sensor 1 is moved with a rotational rate 104 about axis of rotation 103′ perpendicular to main plane of extension 100, then as a function of drive movements 202, 202′, opposite-phase detection movements 201, 201′ of the two seismic masses 20, 20′ are brought about. In order to detect detection movements 201, 201′, seismic mass 20 (or, correspondingly, further seismic mass 20′) has a detection arrangement 25 in a recess 22′, detection arrangement 25 being in particular detection electrodes.

The rotational rate sensor shown here is also referred to as an omega-Z rotational rate sensor. Because both drive movement 202, 202′ and detection movement 201, 201′ take place parallel to main plane of extension 100, according to the present invention it is advantageously possible to set a defined oblique force, or quadrature offset force, via a slightly asymmetrical realization of the plurality of spring elements 41, 41′, 42, 42′ of spring system 40.

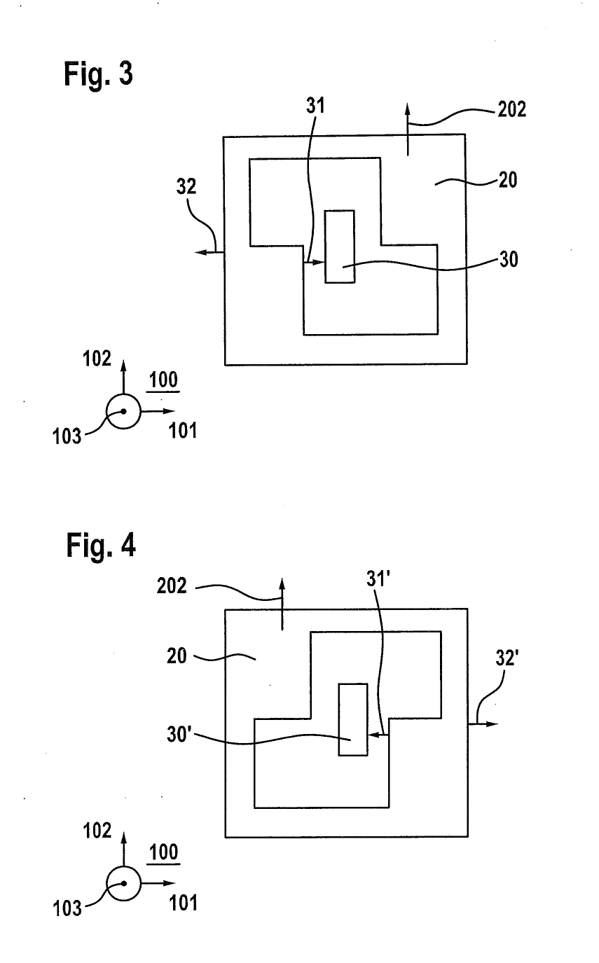

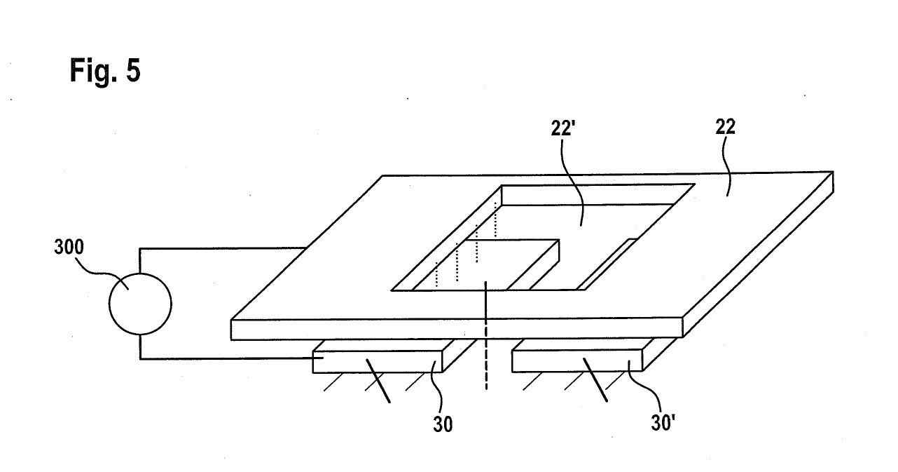

FIGS. 3 through 5 show compensating arrangement 30, 30′ according to various specific embodiments of the present invention in a schematic top view. FIG. 3 shows that, given a drive movement 202 of seismic mass 20 oriented in Y direction 102, a compensating force is produced, by compensating arrangement 30 coupled to substrate 10, in a compensation direction 31 oriented in an X direction 101. Here, compensating arrangement 30 is fashioned as a compensation electrode connected in stationary fashion to substrate 10, the compensating electrode extending in a recess of seismic mass 20. Such a compensating arrangement 30 is used for example to compensate an overall quadrature force that is preset in a preferred direction 32 that is antiparallel to X direction 101. FIG. 4 shows that, given a drive movement 202 of seismic mass 20 oriented in Y direction 102, a compensating force is produced, by another compensating arrangement 30′ coupled to substrate 10, in another compensation direction 31′ oriented antiparallel to X direction 101. Here, the other compensating arrangement 30′ is fashioned as another compensating electrode 30′ connected in stationary fashion to substrate 10, the other compensating electrode 30′ extending in a recess of seismic mass 20. Such an other compensating arrangement 30′ is for example used to compensate an overall quadrature force that is preset in a parallel other preferred direction 32′ aligned with X direction 101. According to the present invention, rotational rate sensor 1 has either compensating arrangement 30 or other compensating arrangement 30′. In this way, advantageously the space requirement of rotational rate sensor 1 (due in particular to the omitted additional wiring of the now-obsolete quadrature compensation direction) and/or the signal quality of the detection signal is improved, and/or the production costs are lowered. With the specific embodiment shown in FIG. 5, a compensating force is always produced from of the second mass element 22 at one of the compensating electrodes 30, 30′ [sic]. Here, second mass element 22 has a recess 22′, and when there is a movement of second mass element 22 along a connecting line between the two compensating electrodes 30, 30′, a compensating force is produced that, given a connection of compensating electrode 30, decreases, and given a connection of further compensating electrodes 30′ increases when the movement takes place (to the right in the drawing). In this way, compensating forces can be produced that are proportional to an amplitude of the deflection of second mass element 22 and that are oriented perpendicular to the substrate plane.

FIG. 6 shows a rotational rate sensor 1 according to a specific embodiment of the present invention, in a perspective view. Rotational rate sensor 1 shown here corresponds essentially to the specific embodiments described in FIGS. 1 and 2, first springs 41, 41′ here being situated in a first region 40′, and second springs 42, 42′ being situated in a second region 40″. Here, first springs 41, 41′ overlap with second springs 42, 42′ along a direction of projection parallel to drive direction 102′. Here, structural widths 43 of first spring elements 41, 41′ are increased by a width difference in comparison with an initial width, and further structural widths 43′ of second spring elements 42, 42′ are reduced by the width difference. Here, the width difference may be 1 to 30 nm, particularly may be 3 to 20 nm, quite particularly may be 5-10 nm. Along a further projection direction perpendicular to axis of rotation 103′ and to drive direction 102′, here in particular first region 40′ of seismic mass 20 and second region 40″ of further seismic mass 20′, as well as second region of seismic mass 40″ and first region 40′ of the further seismic mass, are situated in overlapping fashion. The overall rigidity of the 8 spring elements 41, 41′, 42, 42′, situated in first and second regions 40′, 40″ of the two seismic masses 20, 20′, in this way continue to correspond to that of 8 springs that have the initial width. The width difference may be smaller by approximately an order of magnitude than the initial width, so that the frequencies of a drive mode and/or detection mode of seismic masses 20, 20′ are not significantly modified, or are essentially not modified, by the asymmetrical realization of spring elements 41, 41′, 42, 42′. Nonetheless, according to the present invention the desired oblique force, or quadrature offset force, is advantageously produced, so that the drive mode is given a portion in the detection direction (and vice versa). In this way, for example a quadrature offset is advantageously produced.

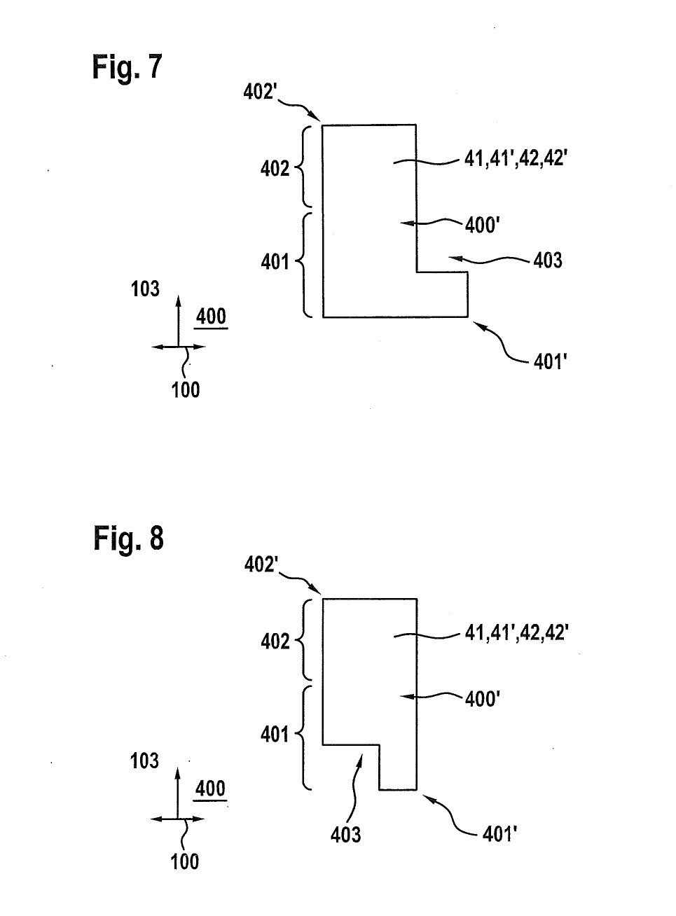

FIGS. 7 and 8 shows spring elements 41, 41′, 42, 42′ according to various specific embodiments of the present invention in schematic sectional views, the spring elements extending essentially perpendicular to the plane of the drawing. FIG. 7 shows a spring element 41, 41′, 42, 42′ for a rotational rate sensor 1, having a detection direction 103 perpendicular to main plane of extension 100 of substrate 10. Here, in particular seismic mass 20 is formed from more than one functional layer 401, 402, which are for example structured separately or individually. In this way, it is advantageously possible to impart an asymmetry, for example through different spring characteristics of spring elements 41, 41′, 42, 42′, i.e. to preset the quadrature offset force in a preferred direction 32. This is achieved for example in that a spring element 41, 41′, 42, 42′ has an L-shaped spring cross-sectional surface 400′ in order for example to induce an oblique movement. Here, for example spring cross-sectional surface 400′ is parallel to a transverse plane 400, transverse plane 400 being situated perpendicular to the main plane of extension and parallel to detection direction 103, or Z direction 103. For example, first mass element 21 is coupled with a first end 401′ (in FIG. 7, the underside of transverse plane 400) in a first plane parallel to main plane of extension 100 in a first functional layer 401, and second mass element is coupled with a second end 402′ (in FIG. 7 the upper side of transverse plane 400) in a second plane parallel to main plane of extension 100 in a second functional layer 402, these couplings being at a distance from one another in the direction of extension of the spring element. In particular, spring element 41, 41′, 42, 42′ has an opening 403 extending from an edge into spring cross-sectional surface 400′, essentially parallel to direction of projection 103 and/or essentially parallel to drive direction 102′, or main plane of extension 100. In the specific embodiment shown in FIG. 8, the opening is situated essentially in first functional layer 401.

What is claimed is:

1. A rotational rate sensor for detecting a rotational rate about an axis of rotation, comprising:
a substrate;
a seismic mass situated on the substrate, the seismic mass having a first mass element and a second mass element coupled to the first mass element, the first mass element being capable drivable to a drive movement along a drive direction perpendicular to the axis of rotation, the first mass element and the second mass element being deflectable along a detection direction essentially perpendicular both to the drive direction and to the axis of rotation;
at least one compensating arrangement to produce a compensating force acting on the first mass element and/or the second mass element, the compensating force being oriented in a compensation direction essentially parallel to the detection direction;
wherein the at least one compensating arrangement is the only compensating arrangement, the at least one compensating arrangement being configured exclusively to produce the compensating force oriented in the compensation direction, and/or
wherein the rotational rate sensor is configured such that a quadrature offset force acting on the first mass element and/or the second mass element is directed exclusively in a preferred direction opposite and parallel to the compensation direction.

2. The rotational rate sensor of claim 1, wherein the rotational rate sensor includes a spring system to produce the quadrature offset force directed in the preferred direction.

3. The rotational rate sensor of claim 1, wherein the first mass element is coupled to the second mass element by a spring element of the spring system, the spring element being pre-tensioned to produce the quadrature offset force directed in the preferred direction.

4. The rotational rate sensor of claim 1, wherein the spring system has a plurality of spring elements that couple the first and second mass element, the plurality of spring elements of the spring system having different spring characteristics.

5. The rotational rate sensor of claim 1, wherein the spring structural widths, spring structural heights, and/or spring lengths of at least two spring elements of the plurality of spring elements differ by from 3 to 40 nm.

6. The rotational rate sensor of claim 1, wherein the first mass element and the second mass element are formed at least partly from different functional layers, the functional layers being situated one over the other along a projection direction perpendicular to a main plane of extension of the substrate, the spring element of the spring system having a spring cross-section, so that it is not always the case that one of the main axes of inertia lies parallel to the substrate plane, the spring elements being coupled at a first end to the first mass element, the spring element of the spring system being coupled at a second end to the second mass element.

7. The rotational rate sensor of claim 1, wherein the at least one compensating arrangement is configured for the compensation at least of the quadrature offset force oriented in the preferred direction using the compensating force oriented in the compensation direction, the compensating force and the quadrature offset force essentially canceling one another.

8. The rotational rate sensor of claim 1, wherein the at least one compensating arrangement is a compensating electrode connected to the substrate, the compensating electrode being configured to produce the compensating force as a function of a quadrature voltage applied between the compensating electrode and the second mass element.

9. A production method for producing a rotational rate sensor for detecting a rate of rotation about an axis of rotation of the rotational rate sensor, the method comprising:
providing a substrate in a first production task, a seismic mass being situated on the substrate, a first mass element and a second mass element, coupled to the first mass element, being formed from the seismic mass, wherein the first mass element is situated so as to be drivable to a drive movement along a drive direction perpendicular to the axis of rotation, the first mass element and the second mass element being situated so as to be deflectable along a detection direction essentially perpendicular both to the drive direction and to the axis of rotation, and wherein at least one compensating arrangement is situated on the rotational rate sensor, the at least one compensating arrangement being configured to produce a compensating force acting on the first mass element and/or the second mass element, the compensating force being oriented in a compensation direction essentially parallel to the detection direction;
wherein in a second production task, at least one of the following is satisfied: (i) as the only compensating arrangement, the at least one compensating arrangement is situated on the rotational rate sensor, the at least one compensating arrangement being configured exclusively for the production of the compensating force oriented in the compensation direction, and (ii) the rotational rate sensor is configured so that a quadrature offset force acting on the first mass element and/or the second mass element is directed exclusively in a preferred direction opposite and parallel to the compensation direction.

10. A quadrature compensation method for a rotational rate sensor, the method comprising:
driving the first mass element to the drive movement along the drive direction;
producing the compensating force on the second mass element, oriented in the compensation direction, through application of a quadrature voltage between the at least one compensating arrangement and the second mass element;
wherein at least one of the following is satisfied: (i) the compensating force acting on the second mass element exclusively in the compensation direction is produced only by the at least one compensating arrangement, and (ii) a quadrature offset force is produced, the quadrature offset force being directed exclusively in the preferred direction;
wherein the rotational rate sensor for detecting a rotational rate about an axis of rotation, includes:
a substrate;
a seismic mass situated on the substrate, the seismic mass having a first mass element and a second mass element coupled to the first mass element, the first mass element being capable drivable to a drive movement along a drive direction perpendicular to the axis of rotation, the first mass element and the second mass element being deflectable along a detection direction essentially perpendicular both to the drive direction and to the axis of rotation;
at least one compensating arrangement to produce a compensating force acting on the first mass element and/or the second mass element, the compensating force being oriented in a compensation direction essentially parallel to the detection direction;
wherein the at least one compensating arrangement is the only compensating arrangement, the at least one compensating arrangement being configured exclusively to produce the compensating force oriented in the compensation direction, and/or
wherein the rotational rate sensor is configured such that a quadrature offset force acting on the first mass element and/or the second mass element is directed exclusively in a preferred direction opposite and parallel to the compensation direction.

11. The rotational rate sensor of claim 1, wherein the spring system has a plurality of spring elements that couple the first and second mass element, the plurality of spring elements of the spring system having different spring characteristics, including a spring structural width, a spring structural height, a spring length, a spring cross-sectional surface extending essentially parallel to the drive direction, a spring type, a spring rigidity sensor, and/or a spring material.

12. The rotational rate sensor of claim 1, wherein the spring structural widths, spring structural heights, and/or spring lengths of at least two spring elements of the plurality of spring elements differ by from 5 to 30 nm.

13. The rotational rate sensor of claim 1, wherein the spring structural widths, spring structural heights, and/or spring lengths of at least two spring elements of the plurality of spring elements differ by from 10 to 20 nm.
